(19) United States
(12) Patent Application Publication
(10) Pub. No.: US 2018/0231214 A1
(43) Pub. Date: Aug. 16, 2018

(54) MULTI-FUNCTIONAL FLASH LIGHTS

(71) Applicant: Aixia Bian, Shanghai (CN)

(72) Inventor: Aixia Bian, Shanghai (CN)

(21) Appl. No.: 15/581,807

(22) Filed: Apr. 28, 2017

Related U.S. Application Data
(60) Provisional application No. 62/457,289, filed on Feb. 10, 2017.

(51) Int. Cl. F21V 14/06; F21L 4/00; F21L 4/08; F21V 31/00; F21V 23/04; G08B 21/18

(52) U.S. Cl. CPC F21V 14/065; F21L 4/005; F21L 4/085; F21V 21/0885; F21V 23/0414; G08B 21/182; F21V 31/005

(57) ABSTRACT

The present invention provides a multi-functional flashlight which includes an elongated housing with a forward end and a back end, and a head unit extensibly connected to the forward end of the elongated housing; the head unit has a first and second part, which are rotably connected to each other such that the rotation of the first part with respect to the second part causes a beam angle of a lighting element to adjust.

### REFERENCE TO RELATED APPLICATION

The present application claims priority to U.S. Application No. 62/457,289, entitled “Multi-Functional Flash Lights” filed on Feb. 10, 2017, the contents of which are incorporated herein in their entirety.

### FIELD OF THE INVENTION

The present description relates generally to portable devices used for illuminating spaces.

### BACKGROUND OF THE INVENTION

Advances in technology have enabled lighting devices to become increasingly lightweight and portable. Light emitting diodes (LEDs) are capable of efficiently converting electrical energy into light with little waste heat, allowing them to provide extended illumination with portable energy sources, such as batteries.

Portable lanterns and the like are used in a variety of situations. Some are used for area illumination in spaces without dedicated lighting. Others are used for assisting visibility in hard to reach place like under vehicles. These devices are especially useful in the event of external power loss.

It is an object of this disclosure to provide an improved portable lighting solution that can be carried by a user to provide light in the area they are working as needed.

It is a further object of this disclosure to provide an improved portable lighting solution with a longer lasting power source.

It is a further object of this disclosure to provide an improved portable lighting solution that is dust and water resistant.

### SUMMARY OF THE INVENTION

A multi-functional flashlight includes an elongated housing with a forward end and a back end, a head unit extensibly connected to the forward end of the elongated housing. The head unit has a first and second part, which are rotably connected to each other such that the rotation of the first part with respect to the second part causes a beam angle of a lighting element to adjust. A battery system is positioned within the housing and is operably connected to and enabling the lighting element to emit light.

A multi-functional flashlight includes an elongated housing with a forward end and a back end, and a head unit is extensibly connected to the forward end of the elongated housing. The head unit has a first and second part, which are rotably connected to each other such that the rotation of the first part with respect to the second part causes a beam angle of a lighting element to adjust. A charging socket is located on a portion of the housing that is covered by the extensible connection between the housing and the head unit. That extensible portion is sealed when in a fully collapsed position. A rotary switch for turning the lighting element on or off is positioned around the housing. A rechargeable battery system operably connected to and enabling the lighting element to emit light. The housing and head unit are adapted to resistant to water and dust.

### BRIEF DESCRIPTION OF THE DRAWINGS

FIG. 1 is a back view of a flash light according to the teachings of this invention.

FIG. 2 is a side view from the bottom of the flash light of FIG. 1, opposite to the end with lamp head.

FIG. 3 is a front view of a flash light of FIG. 1, showing optional side LED light, and a magnetism rotary switch next to the lamp head.

FIG. 4 is a front side view of a flash light of FIG. 1, showing the lamp head, and a side LED light.

FIG. 5 is another side view of a flash light of FIG. 1, showing a magnetism rotary switch next to the lamp head.

FIG. 6 is yet another side view of a flash light of FIG. 1, showing a magnetism rotary switch next to the lamp head.

FIG. 7 is yet another side view of a flash light of FIG. 1, showing a side LED, a Magnetism rotary switch in the open position exposing the charging socket next to the lamp head.

FIG. 8 is another side view of a flash light of FIG. 1 extended, showing a magnetism rotary switch and the lamp head.

FIG. 9 is a vertical view of a flash light of FIG. 1.

FIG. 10 is a side view of another flashlight according to the teachings of this invention.

FIG. 11 is a front side perspective view from the front of the flashlight of FIG. 9 showing the lamp head.

FIG. 12 is a rear side perspective view from the front of the flashlight of FIG. 9 showing the end opposite the lamp head.

FIG. 13 is a perspective view of a flashlight of FIG. 9 extended, showing optional side LED light, and a magnetism rotary switch next to the lamp head.

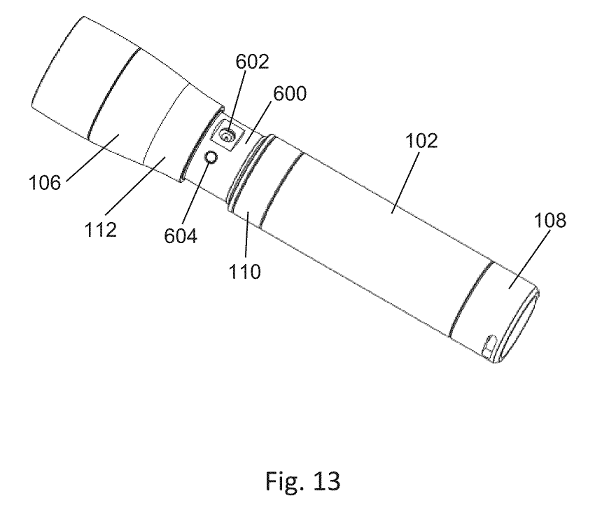

### DETAILED DESCRIPTION OF THE INVENTION

The following description of example methods and apparatus is not intended to limit the scope of the description to the precise form or forms detailed herein. Instead the following description is intended to be illustrative so that others may follow its teachings.

In the following description, the terms “water resistant” or “dust resistant” are used. These terms are set under ANSI/IEC-60529 which promulgates certain standards for the degrees of protection granted against intrusion by both solid objects and water. Solid objections include dust, debris, and even accidental conduct by the user's body during use. The terms “water resistant” or “dust resistant” on their own do not necessarily mean that no dust or no water will enter the device.

The terms “light emitting diode” and “LED” are also used in the following description. One of ordinary skill will appreciate that an LED describes a wide variety of two lead semiconductors that emit light by electroluminescence when a voltage differential is applied. LED lights can be in variety of sizes and typically come in either through-hole or surface mount configurations.

The present application discloses multi-functional portable pen light. An example flashlight is includes an elongated housing with a lighting element at one end. Opposite this end is a tail cap. Other mounting points are included at the end of the housing. The lighting element in this example is one or more LED placed within a focusing housing. In the central portion of the housing, a rotatable switch is positioned to engage the device.

The example multi-functional lighting apparatus may be powered via replaceable or rechargeable batteries. In some instances, the multi-functional lighting apparatus includes a charging port into which a connector of a power source can be inserted to supply power to rechargeable batteries of the multi-functional lighting apparatus. In other instances, the multi-functional lighting apparatus includes a receptacle with conductive contacts into which one or more batteries may be inserted for powering the multi-functional lighting apparatus.

In one example situation, the consumer, when additional lighting is needed as in a power outage or repair task, the consumer removes the flashlight and twists the switch to activate the light. A rotatable focus allows the user to narrow the beam. After the use is finished, the user can twist the head unit housing to reveal the charging port. Access unopposed, the user may engage the plug and restore power to the device.

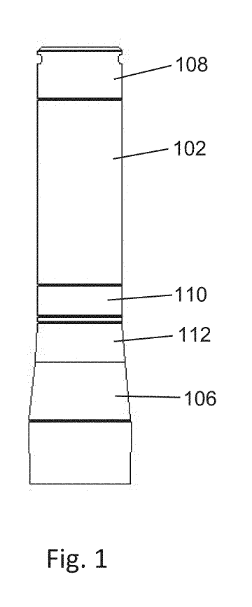

Referring now to FIG. 1, the flashlight 10 is shown in a side view. The elongated housing 102 is connected to the head unit 106 at one end via an extensible portion. At the opposite end, the tail cap 108 is fixed with clip 104 positioned between the two respectively.

The housing 102 is hollow and serves to protect the internal components of the flashlight 10 and provide structure to the device as a whole. The housing 102 in the example flashlight is made of a hard plastic material. In other examples, the housing 102 is made of metal or any suitable stiff material that can support the other components of the flashlight 10.

At the top of the flashlight, the clip 104 fixed between the primary structure, housing 10, and the tail cap 108. The clip 104 in the example shown is made of metal. It is adapted to hang on a belt of a user. In other examples the clip 104 may be adapted to fit other uses, such as being clipping to a car frame as in repair or affixing to a helmet to aid in vision.

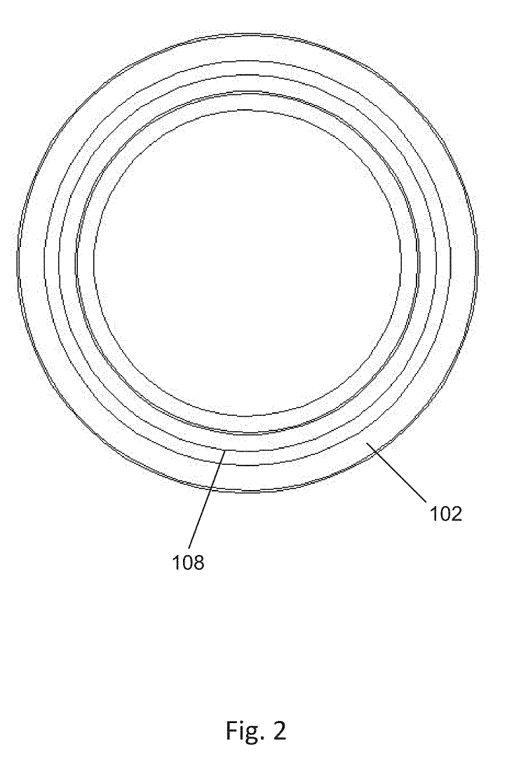

The tail cap 108, shown in the view from that end in FIG. 2, protects the end of the flashlight 10 and seals the components into the housing 102. Here, the tail cap 108 is permanently affixed to the housing 102. In some examples, the tail cap 108 is threaded and removably attach to the housing 102.

Inside the flashlight 10, there are electrical components (not shown) such as a battery and circuits that power the LEDs. The example flashlight 10 contains a lithium ion battery, but could also include another cell or series of cells rechargeable, such as those made of nickel cadmium, or alternatively a single use, non-rechargeable battery, such as those made of alkaline. One of ordinary skill in the art will appreciate that internal components in the flashlight 10 may also contain charging and discharging circuits, heat sinks, and other electronic components.

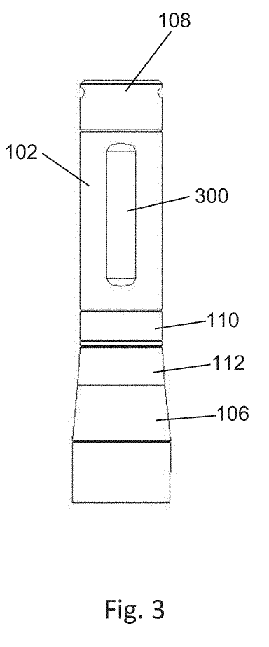

On the housing 102, a flat portion 300 is positioned as shown in FIG. 3. The flat portion 300 makes the flashlight more easily held and less likely to roll away from the user when set down. In the example, this flat portion 300 is only positioned on one side. The flat portion 300 is used to keep the portable light from rolling across a surface in some versions, but may also be used to provide a flat area to provide branding or labeling.

The head unit 106 comes in two parts: a forward part and a rearward part. These two parts can be rotated with respect to each other in an extension-type lamp head. Doing so rotates a focusing element, thereby adjusting the beam angle. This feature gives the user control over the intensity and width of the light emitted from the device. In the example shown, the lighting element 400 (described below) is translated normal to the direction of rotation to move the light source within the head unit 106.

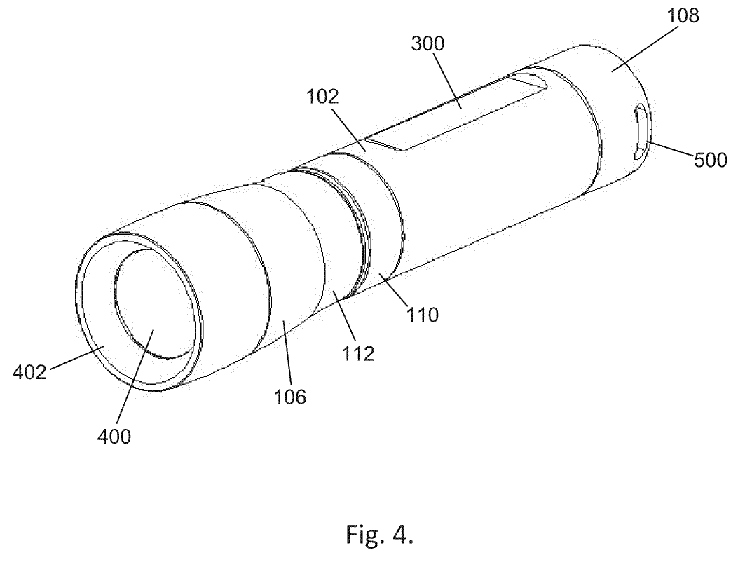

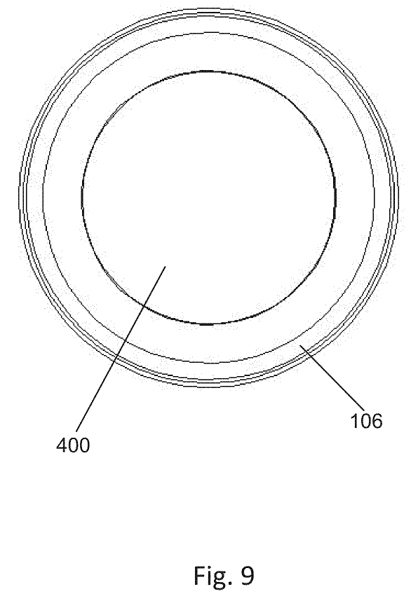

Switch 110 activates the device and engages the lighting element 400 as shown in FIGS. 4 and 9. The switch 110 is a rotary magnetic feature in the example shown. By a simple twist, the user can engage and disengage the device. The switched design shown also has no gaps for debris or water to infiltrate, but in other examples sealed buttons or other suitable alternative buttons may be used.

The lighting element 400 is a high power/SMD LED positioned within the head unit 106. The lighting element 400 is electrically coupled to the interior components of housing 102. The end of head unit 106 is covered with a protective translucent cover, usually plastic or glass. Further, a reflector inside of light shield 402 is positioned to cooperate with the variable focusing element described above, for example, allowing the LED to translate with respect to the contour of the reflector.

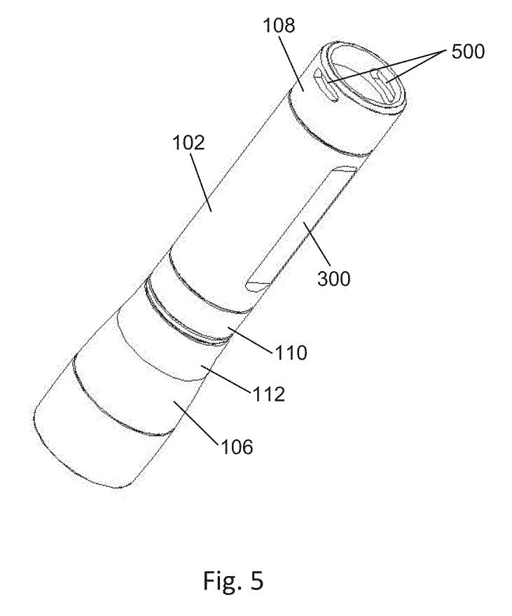

Further, as shown in FIG. 5, a plurality of apertures 500 are included in the tail cap 108. The apertures 500 are used to attach the flashlight 10 to another objection. In some examples, these are used for advertising racks. In other examples, these are used to connect the flashlights to other equipment or locales, e.g. a carabineer could be attached through the aperture 500 to hang the flashlight off of a backpack.

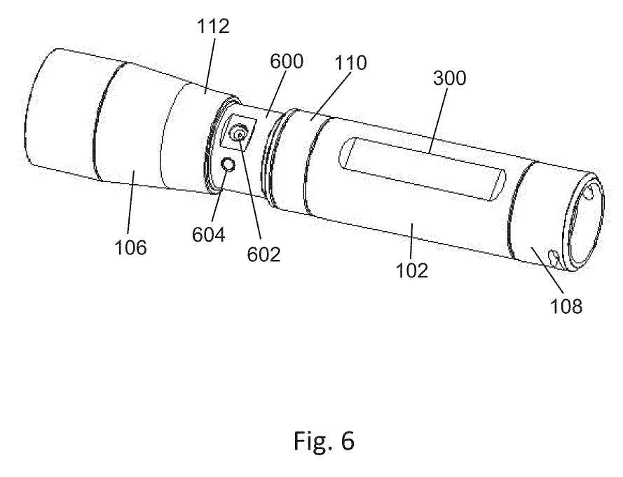

In normal use, the flashlight 10 is in its collapsed configuration as shown in FIG. 1-5. By rotating the housing with respect to the head unit 106, the flashlight 10 can be transitioned to the extended position shown in FIG. 6 by a simple action of the user. This reveals the embedded portion 600 hidden in normal use with water resistant charging socket. The embedded portion 600 includes a charging port 602 and a charging indicator 604 built-in that has been protected from dust, debris, and other dangers. The edges of housing 102 and head unit 106 meet to form a watertight seal. In the example shown, this is accomplished by a press fit. One of ordinary skill in the art would also appreciate that this could be accomplished by a gasket or other sealant.

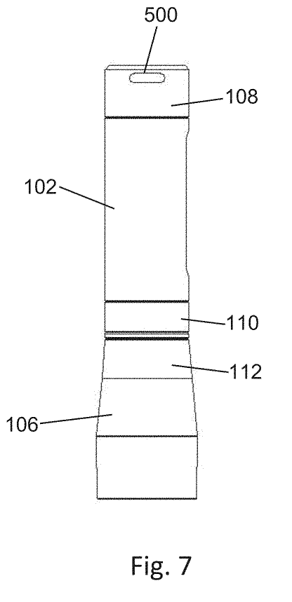

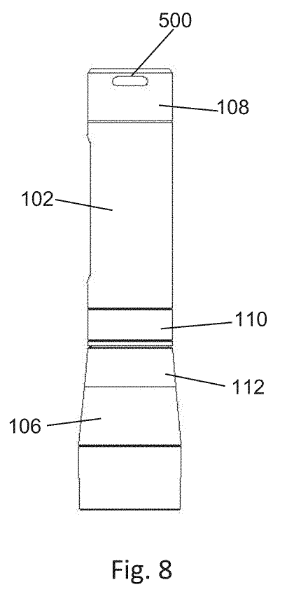

By action of the user, rotating the housing 102 and head unit 106 in the reverse direction, the user can transition the flashlight 10 back to the collapsed configuration as shown in FIG. 7-8. This seals the charging port and indicator off from the environment providing water resistance in a rechargeable design.

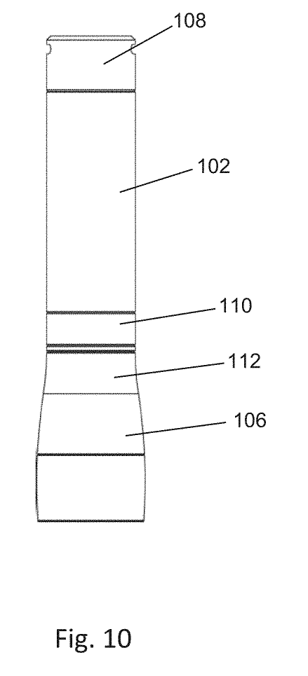

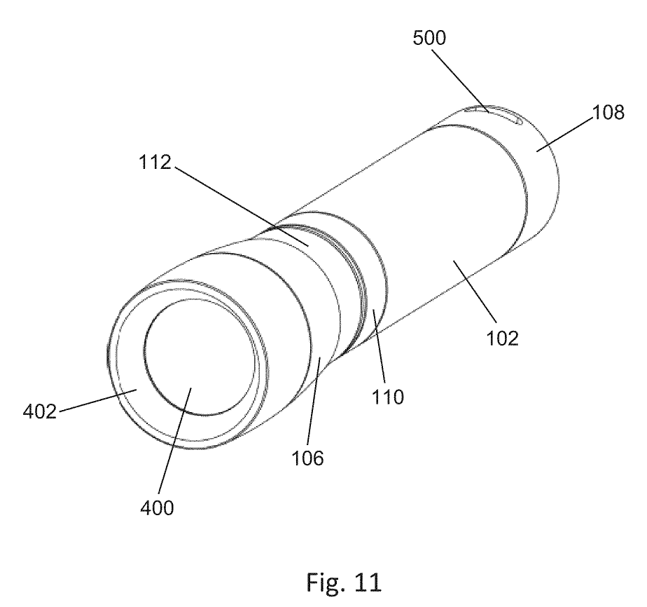

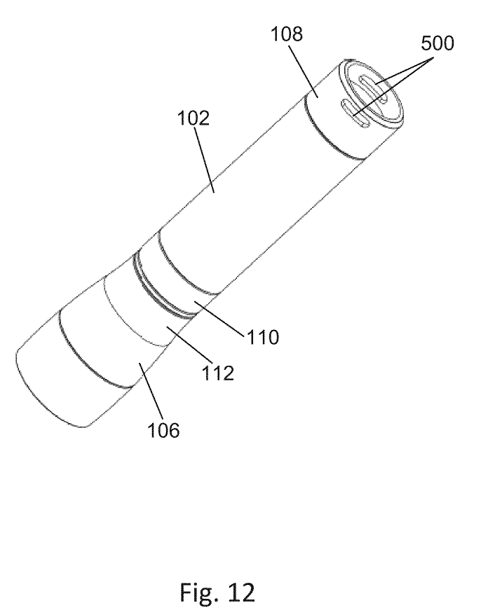

As shown in FIGS. 9-12, another example portable light according to the features of this invention is show. This slightly wider pen light does not have a flat portion 300. It will be understood by one of ordinary skill in the art that the flat portion 300 can be removed from the pen light to simplify manufacturing operations.

The design of the flashlight provides a strongly constructed design, which allows product to be dropped safely from 1.5 meters. The rotating protection granted to the sealed charging port and sealed housing grants it IP54 water and dust resistance, allowing it to be used indoors and outdoors. The design of flashlight 10 prevents contact and the ingress of dust of more than a de minimis amount that provides no harm to the function of the device. It is also shielded from splashing water such that incidental contact with but not submersion in water.

Although certain example methods and apparatuses have been described herein, the scope of coverage of this patent is not limited thereto. On the contrary, this patent covers all methods, apparatuses, and articles of manufacture fairly falling within the scope of the appended claims either literally or under the doctrine of equivalents.

What is claimed is:

1. A multi-functional flashlight, comprising:
an elongated housing with a forward end and a back end;
a head unit extensibly connected to the forward end of the elongated housing, the head unit including a first part and second part, wherein the first part and second part are rotably connected such that the rotation of the first part with respect to the second part causes a beam angle of a lighting element to adjust;
a rotary switch for turning the lighting element on or off positioned on and substantially around the housing; and
a battery system coupled to an inside of the housing and operably connected to and enabling the lighting element to emit light.

2. The flashlight of claim 1, wherein the battery system is rechargeable and the flashlight further comprises a charging socket.

3. The flashlight of claim 2, wherein the battery system is a lithium-ion battery rechargeable with an A/C or D/C power source.

4. The flashlight of claim 2, further comprising a charging indicator.

5. The flashlight of claim 2, wherein the charging socket is located on portion of the housing that is covered by the extensible connection between the housing and the head unit.

6. The flashlight of claim 5, wherein the extensible portion is sealed when in a fully collapsed position.

7. The flashlight of claim 1, wherein the flashlight is resistant to extreme shock or pressure.

8. The flashlight of claim 1, wherein the flashlight is resistant to water or dust.

9. The flashlight of claim 1 wherein the rotary switch is magnetically coupled to the housing.

10. The flashlight of claim 1, further comprising a mounting aperture at the back end of the housing.

11. A multi-functional flashlight, comprising:
an elongated housing with a forward end and a back end;
a head unit extensibly connected to the forward end of the elongated housing, the head unit including a first and second part, wherein the first part and second part are rotably connected such that the rotation of the first part with respect to the second part causes a beam angle of a lighting element to adjust;
a charging socket located on a portion of the housing that is covered by the extensible connection between the housing and the head unit, wherein the extensible portion is sealed when in a fully collapsed position;
a rotary switch for turning the lighting element on or off positioned on and substantially around the housing; and
rechargeable battery system coupled to an inside of the housing and operably connected to and enabling the lighting element to emit light,
wherein the housing and head unit are adapted to resistant to water and dust.
